(19) United States
(12) Patent Application Publication
(10) Pub. No.: US 2006/0146352 A1
(43) Pub. Date: Jul. 6, 2006

(54) Image processing unit and method thereof

(75) Inventor: Feng-Yi Guan, Taipei (TW)

Correspondence Address: BIRCH STEWART KOLASCH & BIRCH, PO BOX 747, FALLS CHURCH, VA, 22040-0747, US

(73) Assignee: Lite-On it Corporation

(21) Appl. No.: 11/322,225

(22) Filed: Jan. 3, 2006

(30) Foreign Application Priority Data
Jan. 4, 2005 (TW) 94100189

(51) Int. Cl. H04N 1/60

(52) U.S. Cl. 358/1.9; 358/462

(57) ABSTRACT

An image processing unit and the method thereof are provided. The image processing unit includes a multiplexer, a first filter and a second filter. The multiplexer receives an image, calculates a pixel data variance between each pixel and its surrounding pixels and classifies the pixels into a first kind and a second kind according to the variance. The first and the second filter respectively process the first kind and the second kind pixels. The method includes the following steps. At first, an image having a plurality of pixels arranged in matrix is received, wherein each pixel has a pixel data. A pixel data variance between each pixel and its surrounding pixels is calculated, and the pixels are classified into at least a first kind and a second kind according to the variance. The first and the second filter are respectively applied to the first kind and the second kind pixels.

This application claims the benefit of Taiwan Application Serial No. 094100189, filed Jan. 04, 2005, the subject matter of which is incorporated herein by reference.

### BACKGROUND OF THE INVENTION

1. Field of the Invention

The invention relates in general to a data processing method, and more particularly to an image processing method.

2. Description of the Related Art

Digitalized data have the advantages of easy storage, maintenance and editing. It has become a mainstream to convert the data such as voice data and image data which are stored in analog signals to be stored in digital signals.

Generally speaking, conventional digital image processing method applies a smooth filter to the entire frame to remove the noises. Then, a sharpen filter is applied to the entire frame to enforce the edges and enhance image contrast.

However, the effect of conventional image processing might cause off-set effect. Since the image contrast has already been weakened after the smooth filtering processing, the sharpening effect is not significant as usual and may even increase noises. Besides, applying mutually off-set processing to the same frame will result in an unnecessary waste in terms of time and resources.

### SUMMARY OF THE INVENTION

It is therefore the object of the invention to provide an image processing method. The image is classified first and then processed partly, so that each step of image processing is more efficient and that both the required internal resources of the image processing unit and the image processing time are reduced.

According to an object of the invention, an image processing method is provided. The method includes the following steps. At first, an image having a plurality of pixels arranged in matrix is received, wherein each pixel has a pixel data. A pixel data variance between each pixel and its surrounding pixels is calculated, and the pixels are classified into at least a first kind and a second kind according to the variance. The first and the second filter are respectively applied to the first kind and the second kind pixels.

According to another object of the invention, an image processing unit used for processing a video signal is provided. The video signal at least includes an image having a plurality of pixels arranged in matrix, and each pixel has a pixel data. The image processing unit includes a multiplexer, a first filter and a second filter. The multiplexer receives an image, calculates a pixel data variance between each pixel and its surrounding pixels and classifies the pixels into a first kind and a second kind according to the variance. The first and the second filter respectively process the first kind and the second kind pixels.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of an image processing unit according to a preferred embodiment of the invention;

FIG. 2 is a flowchart of an image processing method according to a preferred embodiment of the invention; and

FIG. 3 is a diagram of an image.

### DETAILED DESCRIPTION OF THE INVENTION

The image processing method according to the invention classifies the pixels according to their brightness values first, and then the pixels classified into various kinds are processed separately, so that a better effect of image processing can be achieved or that the processing time can be shortened. A preferred embodiment is exemplified below. However, the preferred embodiment is merely an embodiment under the spirit of the invention and the scope of protection of the invention is not limited thereto.

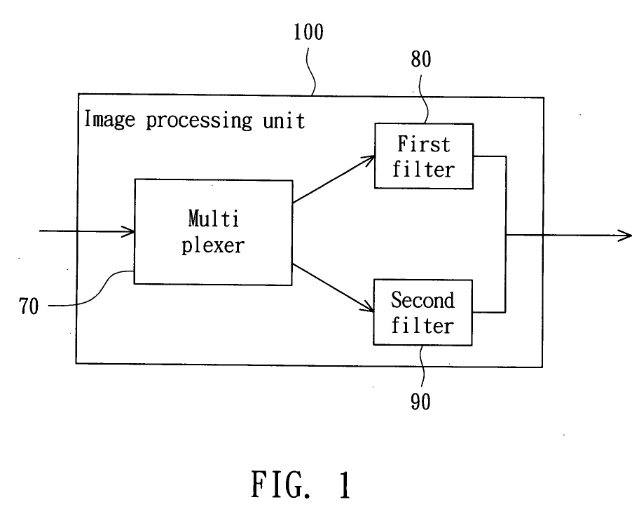

Referring to FIG. 1, a block diagram of an image processing unit according to a preferred embodiment of the invention is shown. In the present embodiment, image processing unit 100 is used for processing a video signal. The image processing unit 100 includes a multiplexer 70, a first filter 80 and a second filter 90. The multiplexer 70 is used for receiving and classifying an image of video signal. The first filter 80 is used for processing a first kind of pixel, and the second filter 90 is used for processing a second kind of pixel.

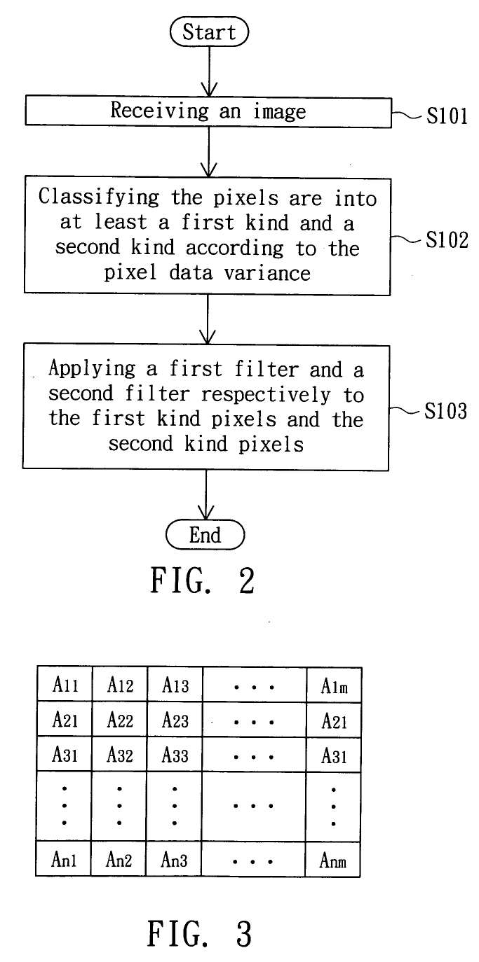

Referring to FIG. 2, a flowchart illustrating an image processing method according to a preferred embodiment of the invention. The image processing method at least includes the steps of S101˜S103. In step S101, an image having a plurality of pixels arranged in matrix is received, and each pixel has a pixel data. In step S102, a pixel data variance between each pixel and its surrounding pixels is calculated, and the pixels are classified into at least a first kind pixel and a second kind pixel according to the variance. In step S103, a first filter and a second are applied to the first kind pixel and the second kind pixel respectively. The classification and processing of image is completed here.

FIG. 3 is a diagram illustrating an image. Referring to both FIG. 2 and FIG. 3, in step S101 the multiplexer 70 receives an image having several pixels P₁₁, P₁₂ . . . and Pₙₘ arranged in matrix, each pixel has a pixel data, and each pixel data includes a red R, a green G and a blue B.

In step S102, the multiplexer 70 classifies the pixels according to a pixel data variance, and the details are disclosed below. At first, the multiplexer 70 calculates the brightness of each pixel A₁₁, A₁₂ . . . and Aₙₘ. The pixel data, such as brightness preferably, of each pixel, which is the average of red R, green G and blue B, is expressed below as formula (1):

$$A = \frac{R + G + B}{3} \qquad ( 1 )$$

Then, the pixel data variance, such as the brightness variance preferably, between each pixel and its surrounding pixels is calculated, and the details are disclosed below. Step 1: the brightness A₂₂ of the pixel P₂₂,is calculated. Step 2: the brightness A₁₁, A₁₂, A₁₃, A₂₁, A₂₃, A₃₁, A₃₂, A₃₃, of the surrounding pixels P₁₁, P₁₂, P₁₃, P₂₁, P₂₃, P₃₁, P₃₂, P₃₃, are also calculated. Step 3: an absolute difference value between the brightness A₂₂ of the pixel P₂₂ and the brightness of each surrounding pixel is respectively calculated. Step 4: the absolute values of the differences are added to obtain a brightness variance V. The calculation is expressed below as formula (2):

$$V = {\sum }_{i = 1 , j = 1}^{i = 3 , j = 3} \vert {A}_{22} - {A}_{ij} \vert \qquad ( 2 )$$

Then, the brightness variance V is compared with the first critical value X₁, and the pixels are classified according to the variance. For example, the pixel whose brightness variance V is larger than the first critical value X₁ is classified as a first kind of pixel, and the pixel whose brightness variance V is smaller than the first critical value X₁ is classified as a second kind of pixel. The application of the invention is not limited to RGB color model. The invention can also be used in YUV or CMYK model, which can also be mixed into white light, to calculate the variance.

In step S103, pixels of various kinds receive various kinds of image processing. A first filter 80 is applied to the first kind pixels, and a second filter 90 is applied to the second kind pixels. For example, the first filter 80 can be a sharpen filter, and the second filter 90 can be a smooth filter. The step of applying a sharpen filter includes the following sub-steps. Firstly, the brightness A1 of a pixel is compared with the average brightness \overline{A2} of its surrounding pixels. Then, the brightness of the pixel is increased if brightness A1 is larger than \overline{A2}, and the brightness of the pixel is reduced if brightness A1 is smaller than \overline{A2}. The step of applying a smooth filter includes the following sub-step. The brightness A1 of a pixel is converted to the average brightness of its surrounding pixels \overline{A²}. In addition, the application of the invention is not limited to when brightness is used as the only criterion of classification. Hue can also be used as the criterion of classification in the invention.

A number of experimental results are disclosed below showing the comparison between the image processing time according to the present embodiment and that according to conventional practice. Referring to table one, the image processing time according to the present embodiment is indeed shorter than conventional image processing time. That is to say, the system resources of the image processing unit can be saved and the image processing time can be shortened if pixels of an image are respectively processed according to their classification.

TABLE ONE

| | image one | image two |
|---|---|---|
| image size (bit) | 2048 × 1536 × 24 | 1024 × 512 × 24 |
| conventional image | 1782 | 281 |
| processing time (ms) | | |
| processing time (ms) | 1344 | 219 |
| according to the | | |
| present embodiment | | |

By classifying an image into a few kinds first and then partly smoothing and partly sharpening the image, the processing step is further simplified, the processing time is shortened, and a clearer image is obtained. With the classification and respective processing, an item of pixel data only needs to be processed once, largely reducing the processing time. Moreover, no off-setting will occur between distinct filters, resulting in an improved image-processing effect. Therefore, the image processing method according to the invention having better effect of image processing and requiring shorter processing time is particularly applicable to movie filter.

Besides, in the step S103 of applying separate image processing to pixels of various kinds, the pixels can be classified into more than two kinds, and then be respectively processed. For example, the step of classifying the pixels into at least two kinds of includes the following sub-steps. A first critical value X₁ and a second critical value X₂ are determined, and the first critical value X₁ is larger than second critical value X₂. The pixel whose brightness variance is larger than the first critical value (V>X₁) is classified as a first kind of pixel, which is applied to a sharpen filter. The pixel whose brightness variance is smaller than second critical value (V<X₂) is classified as a second kind of pixel, which is applied to a smooth filter. The pixel whose brightness variance ranges between the first critical value and a second critical value (X₁>V>X₂) is classified as a third kind of pixel. The pixel data of the third kind of pixel remain the original value. The first kind of pixel and the second kind of pixel can be further classified into several sub-kind, and then be processed respectively and gradationally so as to achieve a processed image of higher delicacy. For example, the first kind of pixel can be further classified into a first sub-kind of pixel and a second sub-kind of pixel. The brightness variance more than twice larger than the first critical value (V>2X₁) is classified into the first sub-kind of pixel. The brightness smaller than the double of the first critical value but larger than the first critical value (2X₁>V>X₁) is classified into the second sub-kind of pixel. When the sharpen filter is applied, the brightness of the first sub-kind of pixel is increased by two times, and the brightness of the second sub-kind pixel is increased by only one time. Similarly, the second kind pixel can be further classified according to the above method with various soothing levels being applied thereto to achieve a processed image of higher delicacy.

According to the image processing unit and method thereof disclosed in above embodiment of the invention, the pixel data of the image is classified firstly and then processed respectively, so that each step of image processing is more efficient and that both the internal resources of the image processing unit and the image processing time are more efficient. At first, the classified image data is smoothed or sharpened according to their classification, not only largely reducing the processing time, but also producing an even better effect of image processing because the processing effects are not off-set. Such image processing method which has better effect and faster processing is particularly applicable to the processing of movie image. Moreover, the classification of image can be further classified into minor categories to which various levels and kinds of image processing are applied, so as to achieve an even delicate image processing. Despite the abovementioned advantages and effects due to this invention, each embodiment of the invention does not necessarily include all of them at the same time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing method, comprising steps of:
receiving an image having a plurality of pixels arranged in matrix, wherein each pixel has a pixel data;
calculating a pixel data variance between each pixel and its surrounding pixels, and classifying the pixels into at least a first kind and a second kind according to the pixel data variance; and
applying a first filter and a second filter respectively to the first kind pixels and the second kind pixels, wherein using the first filter and the second filter to a single pixel will cause off-set effect.

2. The image processing method according to claim 1, wherein the first filter is a sharpen filter, and the second filter is a smooth filter.

3. The image processing method according to claim 2, wherein the step of applying the sharpen filter comprises:
comparing the brightness of a pixel with a brightness average of its surrounding pixels; and
increasing the brightness of the pixel when the brightness is larger than the brightness average; and
reducing the brightness of the pixel when the brightness is smaller than the brightness average.

4. The image processing method according to claim 2, wherein the step of applying the smooth filter comprises:
calculating brightness average of surrounding pixels of a pixel; and
converting the brightness of the pixel to the brightness average.

5. The image processing method according to claim 1, wherein the pixel data variance includes a brightness variance and the step of classifying the pixels comprises:
calculating a brightness of each pixel;
calculating a brightness variance between each pixel and its surrounding pixels; and
comparing the brightness variance with a critical value, and classifying the pixels into the first kind and the second kind according to the comparison.

6. The image processing method according to claim 5, wherein each pixel data comprises a red R, a green G and a blue B, and the brightness of each pixel is the average brightness of the red R, the G data and the blue B.

7. The image processing method according to claim 5, wherein the step of calculating the brightness variance between each pixel and its surrounding pixels further comprises of:
calculating a plurality of brightness values of surrounding pixels; and
respectively calculating an absolute difference between the brightness of the pixel and the brightness of its surrounding pixels, and then summing the absolute values up to obtain the brightness variance.

8. The image processing method according to claim 5, wherein the pixel whose brightness variance is larger than the critical value is classified as the first kind of pixel, and the pixel whose brightness variance is smaller than the critical value is classified as the second kind of pixel.

9. The image processing method according to claim 5, wherein the step of classifying the pixels further comprises:
determining a first critical value and a second critical value, wherein the first critical value is larger than the second critical value;
classifying the pixel whose brightness variance is larger than the first critical value as the first kind of pixel;
classifying the pixel whose brightness variance is smaller than the second critical value as the second kind of pixel;
classifying the pixel whose brightness variance ranges between the first critical value and the second critical value as a third kind of pixel.

10. The image processing method according to claim 9, wherein the step of processing the classified pixels data comprises:
applying a sharpen filter to the first kind of pixels;
applying a smooth filter to the second kind of pixels; and
maintaining the third kind of pixel data.

11. An image processing unit used for processing a video, the video having at least an image, the image comprising a plurality of pixels arranged in matrix, each pixel having a pixel data, and the image processing unit comprising:
a multiplexer for receiving the image, calculating a pixel data variance between each pixel and its surrounding pixels, and classifying the pixels into at least a first kind and a second kind according to the pixel data variance;
a first filter for processing the first kind of pixels; and
a second filter for processing the second kind of pixels.

12. The image processing unit according to claim 11, wherein the first filter is a sharpen filter, and the second filter is a smooth filter.

13. The image processing unit according to claim 12, wherein the multiplexer pre-determines a critical value, and adds a absolute difference between the brightness of each pixel and a brightness average of its surrounding pixels to obtain a brightness variance;
wherein when the brightness variance of the pixel is larger than the critical value, the pixel is classified as the first kind of pixel and applied to the sharpen filter;
wherein when the brightness variance of the pixel is smaller than the critical value, the pixel is classified as the second kind of pixel and applied to the smooth filter.

14. The image processing unit according to claim 13, wherein the pixel data comprises a red R, a green G and a blue B, and the brightness of each pixel is the average brightness of the red R, the G data and the blue B.
